(19) United States
(12) Patent Application Publication
(10) Pub. No.: US 2002/0171610 A1
(43) Pub. Date: Nov. 21, 2002

(54) Organic electroluminescent display with integrated touch-screen

(75) Inventors: MIchael J. Siwinski, Rochester, NY (US); Kathleen Kilmer, Penfield, NY (US); Rodney Feldman, Rochester, NY (US); Andre D. Cropper, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/826,194

(22) Filed: Apr. 4, 2001

(51) Int. Cl. G09G 3/30

(52) U.S. Cl. 345/76; 345/173

(57) ABSTRACT

An organic electroluminescent display, including: a transparent substrate having two faces; light emitting elements of an electroluminescent display formed on one face of the substrate for emitting light through the substrate; and touch sensitive elements of a touch screen formed on the other face of the substrate.

### FIELD OF THE INVENTION

This invention relates generally to color flat panel displays and, more particularly, to an electroluminescent flat panel display with a touch sensitive panel.

### BACKGROUND OF THE INVENTION

Modem electronic devices provide an increasing amount of functionality with a decreasing size. By continually integrating more and more capabilities within electronic devices, costs are reduced and reliability increased. Touch screens are frequently used in combination with conventional soft displays such as cathode ray tubes (CRTs), liquid crystal displays (LCDs), plasma displays and electroluminescent displays. The touch screens are manufactured as separate devices and mechanically mated to the viewing surfaces of the displays.

FIG. 1 shows a prior art touch screen 10. The touch screen 10 includes a transparent substrate 12. This substrate 12 is typically rigid, and is usually glass, although sometimes a flexible material, such as plastic, is used. Various additional layers of materials forming touch sensitive elements 14 of the touch screen 10 are formed on top of the substrate 12. The touch sensitive elements 14 include transducers and circuitry that are necessary to detect a touch by an object, in a manner that can be used to compute the location of such a touch. A cable 16 is attached to the circuitry so that various signals may be brought onto or off of the touch screen 10. The cable 16 is connected to an external controller 18. The external controller 18 coordinates the application of various signals to the touch screen 10, and performs calculations based on responses of the touch sensitive elements to touches, in order to extract the (X, Y) coordinates of the touch.

There are three commonly used touch screen technologies that utilize this basic structure: resistive, capacitive, and surface acoustic wave (SAW). For more information on these technologies, see “Weighing in on touch technology,” by Scott Smith, published in Control Solutions Magazine, May 2000.

There are three types of resistive touch screens, 4-wire, 5-wire, and 8-wire. The three types share similar structures. FIG. 2a shows a top view of a resistive touch screen 10. FIG. 2b shows a side view of the resistive touch screen 10. The touch sensitive elements 14 of the resistive touch screen 10 includes a lower circuit layer 20; a flexible spacer layer 22 containing a matrix of spacer dots 24; a flexible upper circuit layer 26; and a flexible top protective layer 28. All of these layers are transparent. The lower circuit layer 20 often comprises conductive materials deposited on the substrate 12, forming a circuit pattern.

The main difference between 4-wire, 5-wire, and 8-wire touch screens is the circuit pattern in the lower circuit layer 20 and the upper circuit layer 26, and the means for making resistance measurements. An external controller 18 is connected to the touch screen circuitry via cable 16. Conductors in cable 16 are connected to the circuitry within the lower circuit layer 20 and the upper circuit layer 26. The external controller 18 coordinates the application of voltages to the touch screen circuit elements. When a resistive touch screen is pressed, the pressing object, whether a finger, a stylus, or some other object, deforms the top protective layer 28, the upper circuit layer 26, and the spacer layer 22, forming a conductive path at the point of the touch between the lower circuit layer 20 and the upper circuit layer 26. A voltage is formed in proportion to the relative resistances in the circuit at the point of touch, and is measured by the external controller 18 connected to the other end of the cable 16. The controller 18 then computes the (X, Y) coordinates of the point of touch. For more information on the operation of resistive touch screens, see “Touch Screen Controller Tips,” Application Bulletin AB-158, Burr-Brown, Inc. (Tucson, Ariz.), April 2000, pages 1-9.

FIG. 3a shows a top view of a capacitive sensing touch screen 10. FIG. 3b shows a side view of the capacitive sensing touch screen 10. The touch sensitive elements 14 include a transparent metal oxide layer 30 formed on substrate 12. Metal contacts 32, 34, 36, and 38 are located on the metal oxide layer 30 at the corners of the touch screen 10. These metal contacts are connected by circuitry 31 to conductors in cable 16. An external controller 18 causes voltages to be applied to the metal contacts 32, 34, 36, and 38, creating a uniform electric field across the surface of the substrate 12, propagated through the transparent metal oxide layer 30. When a finger or other conductive object touches the touch screen, it capacitively couples with the screen causing a minute amount of current to flow to the point of contact, where the current flow from each corner contact is proportional to the distance from the corner to the point of contact. The controller 18 measures the current flow proportions and computes the (X, Y) coordinates of the point of touch. U.S. Pat. No. 5,650,597, issued Jul. 22, 1997 to Redmayne describes a variation on capacitive touch screen technology utilizing a technique called differential sensing.

FIG. 4a shows a top view of a prior art surface acoustic wave (SAW) touch screen 10. FIG. 4b shows a side view of a SAW touch screen 10. The touch sensitive elements 14 include an arrangement of acoustic transducers 46 and sound wave reflectors 48 formed on the face of substrate 12. The sound wave reflectors 48 are capable of reflecting high frequency sound waves that are transmitted along the substrate surface, and are placed in patterns conducive to proper wave reflection. Four acoustic transducers 46 are formed on the substrate 12 and are used to launch and sense sound waves on the substrate surface. A cable 16 is bonded to the substrate 12, and contains conductors that connect the acoustic transducers 46 to an external controller 18. This external controller 18 applies signals to the acoustic transducers 46, causing high frequency sound waves to be emitted across the substrate 12. When an object touches the touch screen, the sound wave field is disturbed. The transducers 46 detect this disturbance, and external controller 18 uses this information to calculate the (X, Y) coordinate of the touch.

FIG. 5 shows a typical prior art electroluminescent display such as an organic light emitting diode OLED flat panel display 49 of the type shown in U.S. Pat. No. 5,688,551, issued Nov. 18, 1997 to Littman et al. The OLED display includes substrate 50 that provides a mechanical support for the display device. The substrate 50 is typically glass, but other materials, such as plastic, may be used. Light-emitting elements 52 include conductors 54, a hole injection layer 56, an organic light emitter 58, an electron transport layer 60 and a metal cathode layer 62. When a voltage is applied by a voltage source 64 across the light emitting elements 52, via cable 67, light 66 is emitted through the substrate 50, or through a transparent cathode layer 62.

Conventionally, when a touch screen is used with a flat panel display, the touch screen is simply placed over the flat panel display and the two are held together by a mechanical mounting means such as a frame. FIG. 6 shows such a prior art arrangement with a touch screen mounted on an OLED flat panel display. After the touch screen and the OLED display are assembled, the two substrates 12 and 50 are placed together in a frame 68. Sometimes, a narrow air gap is added between the substrates 12 and 50 by inserting a spacer 72 to prevent Newton rings. The thickness and materials in the substrates can degrade the quality of the image. When light passes from the underlying flat panel display through the touch screen, a change in refractive index occurs. Some light is refracted, some light is transmitted, and some light is reflected. This reduces the brightness and sharpness of the display.

U.S. Pat. No. 5,982,004 issued Nov. 9, 1999, to Sin et al. describes a thin film transistor that may be useful for flat panel display devices and mentions that touch sensors may be integrated into a display panel. However, Sin et al. do not propose a method for doing so.

U.S. Pat. No. 6,028,581 issued Feb. 22, 2000, to Umeya describes a liquid crystal display with an integrated touch screen on the same face of a substrate to reduce parallax error due to the combined thickness of the liquid crystal display and the touch screen. This arrangement has the shortcoming that the existing pixel array layout must be significantly modified, incurring additional cost and reducing pixel fill factor.

U.S. Pat. No. 5,995,172 issued Nov. 30, 1999, to Ikeda et al. discloses a tablet integrated LCD display apparatus wherein a touch sensitive layer is formed on the same side of a substrate as the LCD.

U.S. Pat. No. 5,852,487 issued Dec. 22, 1998, to Fujimori et al. discloses a liquid crystal display having a resistive touch screen. The display includes three substrates.

U.S. Pat. No. 6,177,918 issued Jan. 23, 2001, to Colgan et al. describes a display device having a capacitive touch screen and LCD integrated on the same side of a substrate.

There remains a need for an improved touch screen-flat panel display system that minimizes device weight, removes redundant materials, decreases cost, eliminates special mechanical mounting design, increases reliability, prevents Newton rings, and minimizes the degradation in image quality.

### SUMMARY OF THE INVENTION

The need is met according to the present invention by providing an organic electroluminescent display, including: a transparent substrate having two faces; light emitting elements of an electroluminescent display formed on one face of the substrate for emitting light through the substrate; and touch sensitive elements of a touch screen formed on the other face of the substrate.

### ADVANTAGES

The display according to the present invention is advantageous in that it provides a display having a minimum number or substrates, thereby providing a thin, light, easily manufacturable display.

### BRIEF DESCRIPTION OF THE DRAWINGS

FIG. 1 is a schematic diagram showing the basic structure of a prior art touch screen;

FIGS. 2a and 2b are schematic diagrams showing the structure of a prior art resistive touch screen;

FIGS. 3a and 3b are schematic diagrams showing the structure of a prior art capacitive touch screen;

FIGS. 4a and 4b are schematic diagrams showing the structure of a prior art surface acoustic wave touch screen;

FIG. 5 is a schematic diagram showing the structure of a prior art organic electroluminescent display;

FIG. 6 is a schematic diagram showing the combination of a touch screen with a flat panel electroluminescent display as would be accomplished in the prior art;

FIG. 7 is a schematic diagram showing the basic structure of an electroluminescent display with a touch screen according to the present invention;

FIG. 8 is a schematic diagram showing an embodiment of the present invention including a resistive touch screen;

FIG. 9 is a schematic diagram showing an embodiment of the present invention with a capacitive touch screen; and

FIG. 10 is a schematic diagram showing an embodiment of the present invention with a surface acoustic wave touch screen.

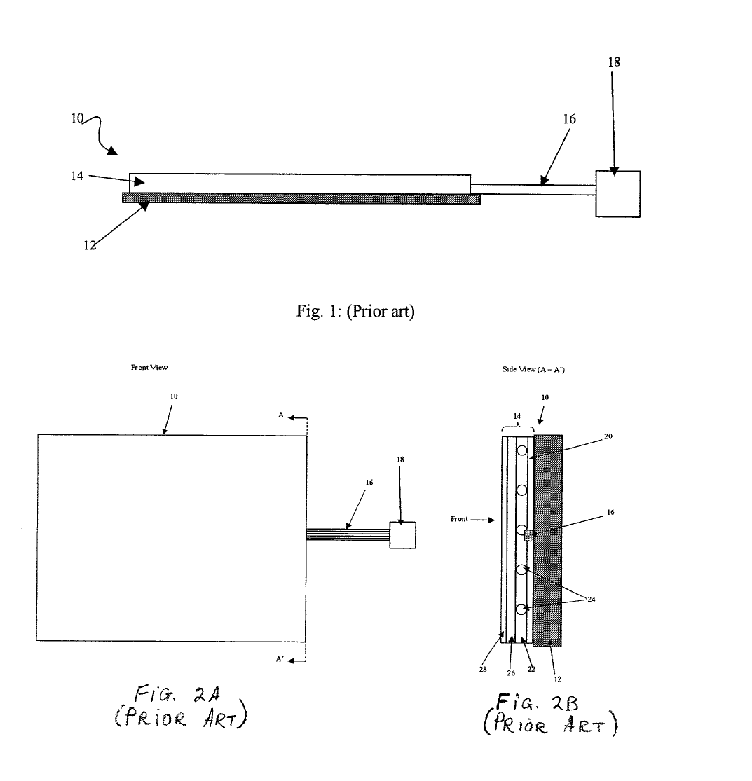

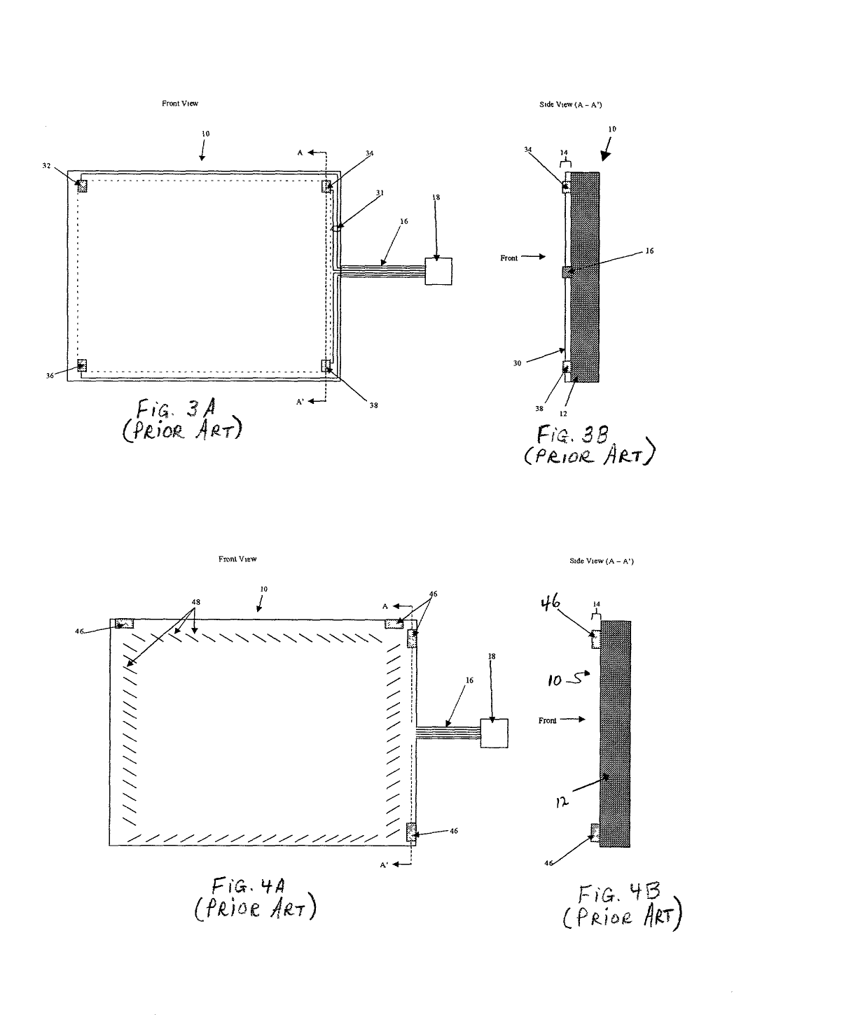

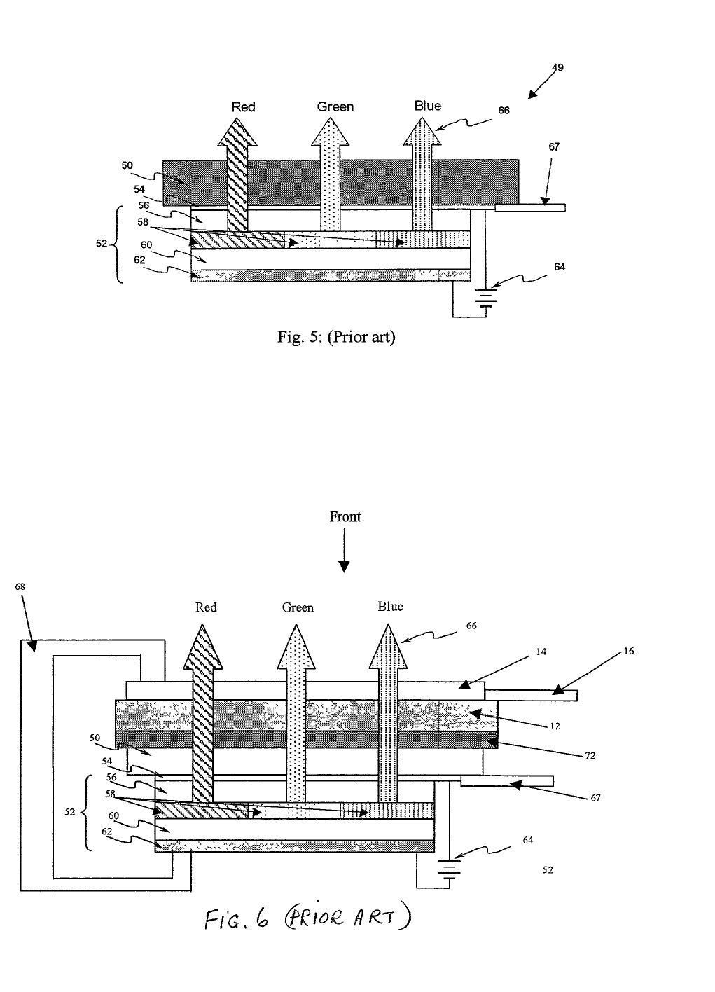

### DETAILED DESCRIPTION OF THE INVENTION

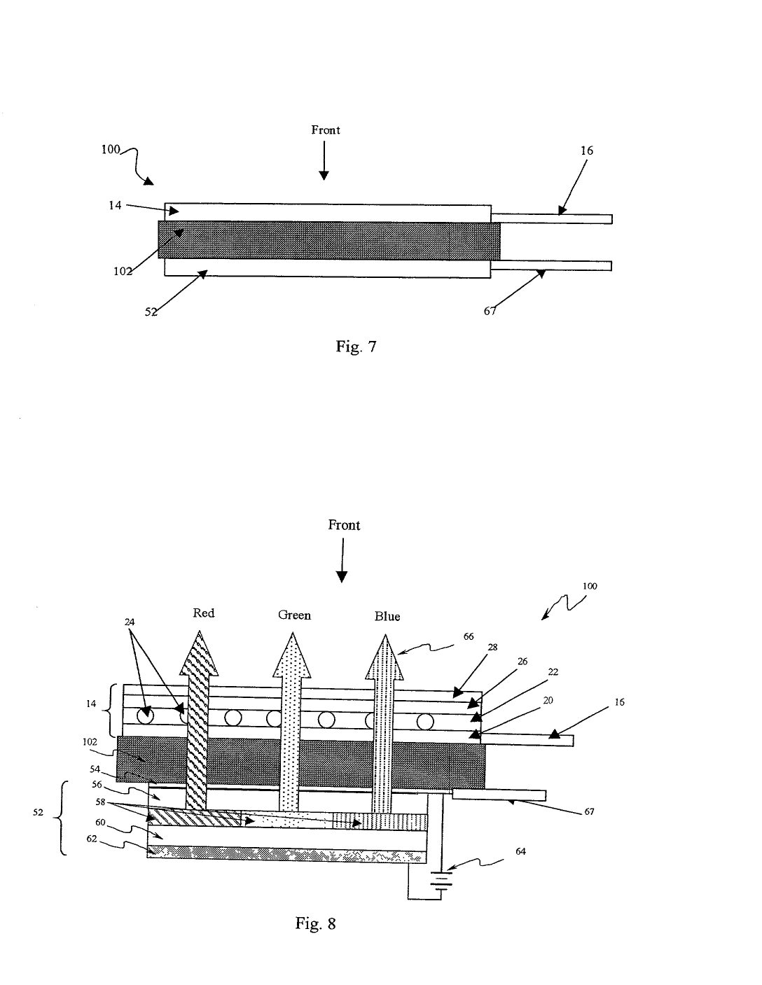

Referring to FIG. 7, an electroluminescent display generally designated 100 according to the present invention includes a single substrate 102 having light emitting elements 52 of an electroluminescent display formed on one face of the substrate for emitting light through the substrate, and touch sensitive elements 14 of a touch screen formed on the other face of the substrate 102. The 30 substrate 102 is made of a transparent material, such as glass or plastic, and is thick enough to provide mechanical support for both the light emitting elements 52 and the touch sensitive elements 14. This improved display eliminates the need for a second substrate, and allows both the light emitting elements 52 of the image display and the touch sensitive elements 14 to be formed on the same substrate without interfering with each other. This reduces system cost, manufacturing cost, and system integration complexity. Various prior art touch screen technologies may be employed in the display 100 as described below.

Referring to FIG. 8, a display 100 including a resistive touch screen according to one embodiment of the present invention is shown. A lower circuit layer 20 and metal interconnections 54 are formed, for example by photolithographically patterning respective conductive layers on opposite faces of substrate 102. The conductive layers comprise for example a semitransparent metal, typically ITO. On the image display side of the substrate 102, a hole injection layer (HIL) 56 is applied to the device over the metal interconnections 54. Then organic light emitters 58 are deposited on top of the HIL layer 56. During the deposition stage, the organic material is patterned for individual colors by either shadow masking or other vacuum deposition techniques. Next, an electron transport layer (ETL) 60 is deposited, followed by a metal cathode layer 62. On the touch screen side of the substrate 102, a flexible spacer layer 22 containing a matrix of spacer dots 24 is laminated on top of the lower circuit layer 20. A flexible upper circuit layer 26 is then attached to the device over the spacer layer 22. The stack is protected by a flexible top protective layer 28 that is laminated on top of the upper circuit layer 26. A cable 16 is attached to the touch screen elements 14, completing the touch screen portion of the display 100. Finally, a cable 67 is attached to the light emitting elements 52, resulting in a fully manufactured display 100.

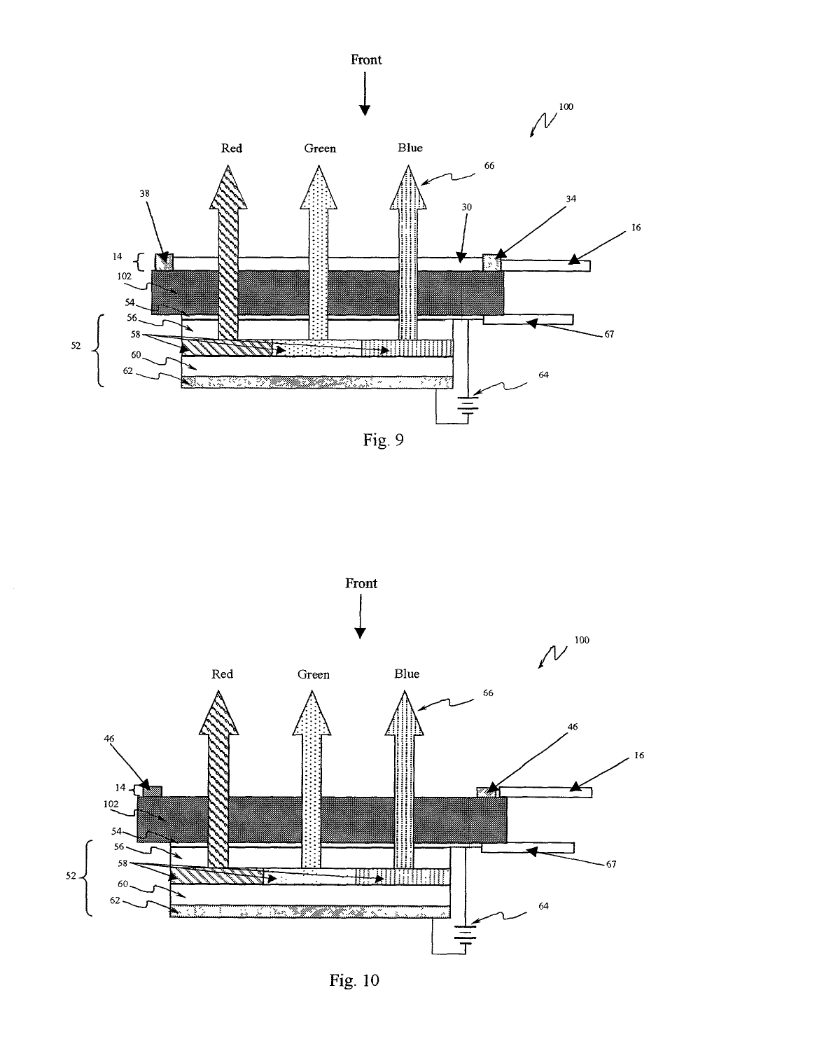

FIG. 9 shows a display 100 with a capacitive touch screen according to the present invention. A substrate 102 is coated on one face (the touch screen face) with a transparent metal oxide layer 30. On the other face of the substrate 102, the light emitting elements 52 of an image display are formed. First, metal interconnections 54 are formed on the substrate 102. Next, a hole injection layer (HIL) 56 is applied to the device over the metal interconnections 54. Then organic light emitters 58 are coated and patterned on top of the HIL layer 56. Next, an electron transport layer (ETL) 60 is deposited, followed by a metal cathode layer 62. Metal contacts 32, 34, 36, and 38 are then placed at the corners of the metal oxide layer 30, completing the touch screen elements 14. Finally, a cable 67 is attached to the light emitting elements 52, and a cable 16 is attached to touch screen elements 14, where the conductors of the cable 16 are connected to the metal contacts 32, 34, 36, and 38, resulting in a fully manufactured display 100.

FIG. 10 shows a display 100 manufactured with a surface acoustic wave touch screen. A series of acoustic surface wave reflectors 48 are etched into one face of substrate 102. Next, an image display 52 is formed on the opposite face of the substrate 102, started by forming metal interconnections 54. Then, a hole injection layer (HIL) 56 is applied to the device over the metal interconnections 54. Organic emitters 58 are then coated and patterned on top of the HIL layer 56. Next, an electron transport layer (ETL) 60 is deposited, followed by a metal cathode layer 62, completing the light emitting elements 52. The touch screen elements 14 are then completed by forming four acoustic transducers 46 on the substrate 102. Finally, a cable 67 is attached to the light emitting elements 52 of the image display, and a cable 16 is attached to the touch sensitive elements 14 of the touch screen, resulting in a fully manufactured display 100.

The invention has been described in detail with particular reference to certain preferred embodiments thereof, but it will be understood that variations and modifications can be effected within the spirit and scope of the invention.

PARTS LIST

| | |
|---|---|
| 10 | touch screen |
| 12 | substrate |
| 14 | touch sensitive elements |
| 16 | cable |
| 18 | controller |
| 20 | lower circuit layer |
| 22 | flexible spacer layer |
| 24 | spacer dot |
| 26 | flexible upper circuit layer |
| 28 | flexible top protective layer |
| 30 | metal oxide layer |
| 31 | circuitry |
| 32 | metal contact |
| 34 | metal contact |
| 36 | metal contact |
| 38 | metal contact |
| 46 | acoustic transducer |
| 48 | acoustic surface wave reflector |
| 49 | OLED flat panel display |
| 50 | substrate |
| 52 | light emitting elements |
| 54 | conductors |
| 56 | hole injection layer |
| 58 | organic light emitters |
| 60 | electron transport layer |
| 62 | cathode layer |
| 64 | voltage source |
| 66 | light |
| 67 | cable |
| 68 | frame |
| 72 | spacer |
| 100 | display with touch screen |
| 102 | substrate |

What is claimed is:

1. An organic electroluminescent display, comprising:
a) a transparent substrate having two faces;
b) light emitting elements of an electroluminescent display formed on one face of the substrate for emitting light through the substrate; and
c) touch sensitive elements of a touch screen formed on the other face of the substrate.

2. The display of claim 1, wherein the electroluminescent display is an organic light emitting diode display (OLED).

3. The display of claim 1, wherein the touch screen is a resistive touch screen.

4. The display of claim 1, wherein the touch screen is a capacitive touch screen.

5. The display of claim 1, wherein the touch screen is a surface acoustic wave touch screen.

6. The display of claim 1, wherein the substrate is glass.

7. The display of claim 1, wherein the substrate is plastic.

8. A method of manufacturing an organic electroluminescent display, comprising the steps of:
a) providing a transparent substrate having two opposite faces;
b) forming conductive layers on opposite faces of the substrate;
c) patterning the respective conductive layers to form a lower circuit layer for resistive touch sensitive elements and metal interconnections for light emitting elements on opposite sides of the substrate;
d) forming a hole injection layer over the metal interconnections;
e) depositing organic light emitters on the hole injection layer;
f) depositing an electron transport layer on the organic light emitters;
g) depositing a metal cathode layer on the electron transport layer;
h) laminating a flexible spacer layer having a matrix of spacer dots onto the lower circuit layer;
i) attaching a flexible upper circuit layer over the spacer layer; and
j) laminating a flexible top protective layer onto the upper circuit layer.

9. A method of manufacturing an organic electroluminescent display, comprising the steps of:
a) providing a transparent substrate having two opposite faces;
b) forming a pattern of transparent metal oxide on one of the faces of the substrate for a capacitive sensing touch screen, the pattern having corners;
c) forming metal interconnections on the opposite face of the substrate;
d) patterning the respective conductive layers to form a lower circuit layer for touch sensitive elements and metal interconnections for light emitting elements on opposite sides of the substrate;
e) forming a hole injection layer over the metal interconnections;
f) depositing organic light emitters on the hole injection layer;
g) depositing an electron transport layer on the organic light emitters;
h) depositing a metal cathode layer on the electron transport layer; and
i) placing metal contacts on the corners of the transparent metal oxide layer.

10. A method of manufacturing an organic electroluminescent display, comprising the steps of:
a) providing a transparent substrate having opposite faces;
b) etching a pattern of surface acoustic wave reflectors into one face of the substrate;
c) forming a conductive layer on the opposite face of the substrate;
d) patterning the conductive layer to form metal interconnections for light emitting elements;
e) forming a hole injection layer over the metal interconnections;
f) depositing organic light emitters on the hole injection layer;
g) depositing an electron transport layer on the organic light emitters;
h) depositing a metal cathode layer on the electron transport layer; and
i) forming acoustic wave transducers on the one side of the substrate.
